(19) United States
(12) Patent Application Publication
(10) Pub. No.: US 2025/0153656 A1
(43) Pub. Date: May 15, 2025

(54) VEHICLE-MOUNTED SHOOTING SYSTEM

(71) Applicant: TILTA INC., Burbank, CA (US)

(72) Inventors: Long MA, Shenzhen (CN); Yaolong LUO, Shenzhen (CN); Wenping ZENG, Shenzhen (CN); Kefeng ZHOU, Shenzhen (CN)

(21) Appl. No.: 18/944,472

(22) Filed: Nov. 12, 2024

(30) Foreign Application Priority Data
Nov. 13, 2023 (CN) 2023230652403

(51) Int. Cl. B60R 11/04; B60R 11/00

(52) U.S. Cl. CPC B60R 11/04; B60R 2011/004; B60R 2011/0056; B60R 2011/0084; B60R 2011/0092

(57) ABSTRACT

A vehicle-mounted shooting system includes a connecting assembly and a sliding rail assembly. The connecting assembly serves to assemble photographic equipment, while the sliding rail assembly includes a sliding rail base, a conveyor belt, and a mobile drive component. The connecting assembly is movably mounted on the sliding rail base and linked to the conveyor belt. The conveyor belt is positioned on the sliding rail base, and the mobile drive component, also situated on the sliding rail base, is drivingly coupled to the conveyor belt to propel its movement relative to the sliding rail base, thereby facilitating the movement of the connecting assembly along the sliding rail base.

### CROSS-REFERENCE TO RELATED APPLICATIONS

The present application for patent claims priority to and the benefit of pending Chinese Application No. 2023230652403, filed Nov. 13, 2023, and hereby expressly incorporated by reference herein as if fully set forth below in its entirety and for all applicable purposes.

### TECHNICAL FIELD

The present disclosure pertains to the technical domain of photographic equipment, specifically addressing a vehicle-mounted shooting system.

### INTRODUCTION

In the production of television dramas, movies, advertisements, live sports events, and other media content, capturing moving scenes, such as interior and exterior vehicle shots, often necessitates filming at high speeds. Currently, these shots are primarily captured using jib arms, which typically involve a fixed base on the vehicle roof. One end of the jib arm rotates around this base, while the other end extends outside the vehicle to facilitate panoramic shots without damaging the vehicle body during movement. However, because of this setup, the equipment occupies a significant amount of space, thereby limiting the shooting environment.

### BRIEF SUMMARY

The present disclosure introduces a vehicle-mounted shooting system that addresses the limitations of existing technologies, as one end of a jib arm rotates around a base, while the other end of the jib arm extends outside the vehicle to facilitate panoramic shots without damaging the vehicle body during movement. However, because of this setup, the equipment occupies a significant amount of space, thereby limiting the shooting environment.

The present disclosure offers the following technical solution:

A vehicle-mounted shooting system, including:
a connecting assembly for assembling photographic equipment;
a sliding rail assembly, which encompasses a sliding rail base, a conveyor belt, and a mobile drive component. The connecting assembly is movably mounted on the sliding rail base and linked to the conveyor belt. The conveyor belt is positioned on the sliding rail base, and the mobile drive component, also situated on the sliding rail base, is drivingly coupled to the conveyor belt to propel its movement relative to the sliding rail base, thereby facilitating the connecting assembly's movement along the sliding rail base.

The beneficial effects include:

In the present disclosure, when it is necessary to switch shooting scenes, the connecting assembly is movable on the sliding rail base and can traverse along with the conveyor belt. Consequently, the conveyor belt can propel the connecting assembly to slide along the sliding rail base, enabling the camera load end to follow this motion to accommodate the user's shooting scene transitions. This arrangement saves the camera load end of the connecting assembly from protruding outside the vehicle body, yet the vehicle-mounted shooting system occupies minimal space and is adaptable to a wide range of shooting environments.

### BRIEF DESCRIPTION OF THE DRAWINGS

To facilitate a comprehensive understanding of the technical solutions embodied in the present disclosure and the prior art, a concise overview of the drawings pertinent to the description of exemplary embodiments or prior art will be provided. It is important to note that the drawings presented below serve as illustrative examples of the present application and should not be construed as exhaustive. Ordinary practitioners in the field can readily derive alternative drawings based on the structural configurations depicted herein, without the need for inventive endeavors.

FIG. 1 is a diagram illustrating the use of a vehicle-mounted shooting system according to some aspects of the disclosure.

FIG. 2 is a diagram illustrating an exploded view of the vehicle-mounted shooting system according to some aspects of the disclosure.

FIG. 3 is a diagram of a sliding rail base according to some aspects of the disclosure.

FIG. 4 is a diagram of a mobile platform according to some aspects of the disclosure.

FIG. 5 is a diagram illustrating an exploded view of a connecting assembly according to some aspects of the disclosure.

FIG. 6 is a diagram illustrating an enlarged view at position A in FIG. 5 of the disclosure.

### REFERENCE NUMERALS OF ELEMENTS

100—vehicle-mounted shooting system; 200—vehicle; 300—photographic equipment;
1—connecting assembly; 11—mobile platform; 111—third sliding groove; 112—mobile block; 113—first end; 114—second end; 115—second sliding groove; 116—through hole; 117—installation groove; 12—camera load end; 13—connecting base; 131—tube clamp; 14—cantilever; 15—counterweight;
2—sliding rail assembly; 21—sliding rail base; 211—first sliding groove; 2111—sliding strip; 212—first fixed base; 213—second fixed base; 214—support part; 2141—first support rod; 2142—second support rod; 2143—suction cup; 2144—fixing clamp; 215—sliding rail; 22—conveyor belt; 23—mobile drive component; 231—mobile drive motor; 2311—output end of mobile drive motor; 232—driving wheel; 233—driven wheel;
3—tensioning assembly; 31—connecting rod; 32—operating part; 321—housing groove; 33—pivot; 34—resistance rod;
4—rotational drive component; 41—slider; 42—housing; 43—rotating drive motor; 431—output end of rotating drive motor; 44—fixed disk;
5—locking assembly; 51—locking block; 52—locking post; 53—locking lever; and 6—stopper.

The objectives, functional characteristics, and aspects of this disclosure shall be further expounded upon through a detailed examination of exemplary embodiments and the accompanying drawings.

### DETAILED DESCRIPTION

The subsequent passages provide a precise and exhaustive portrayal of the technical solutions embodied within this application, drawing upon the illustrative figures. It is to be understood that the enumerated embodiments constitute but a fraction of the broader scope and are not exhaustive. Consequently, any alternative embodiments derived by ordinary technicians in the relevant field, without the necessity for inventive ingenuity, are encompassed within the protective ambit of this application.

Please be advised that directional terminology (e.g., up, down, left, right, front, rear, etc.) employed in the embodiments serves exclusively to elucidate the relative positional arrangements and dynamic states among components within a specific orientational framework as depicted in the drawings. In the event of a change in this orientational framework, the directional designations will naturally align with the new configuration.

Furthermore, the utilization of ordinal indicators such as “first,” “second,” and so forth, in this application, is purely for descriptive clarity and cannot be misconstrued as signifying relative significance or implicitly indicating the number of technical features referenced. As such, expressions constrained by such ordinal designations may encompass one or more of the indicated features, either explicitly or implicitly. Moreover, the phrase “and/or” used throughout this document encompasses three distinct possibilities: Taking A and B as examples, it embraces the technical solution exclusive to A, the technical solution exclusive to B, as well as the technical solution that concurrently satisfies both A and B. Additionally, the integration of technical solutions across distinct embodiments is permissible, albeit contingent upon the feasibility of such integration by ordinary technicians in the field. In instances where the combined technical solutions conflict or are unfeasible, such integrations are deemed non-existent and thereby excluded from the scope of protection afforded by this application.

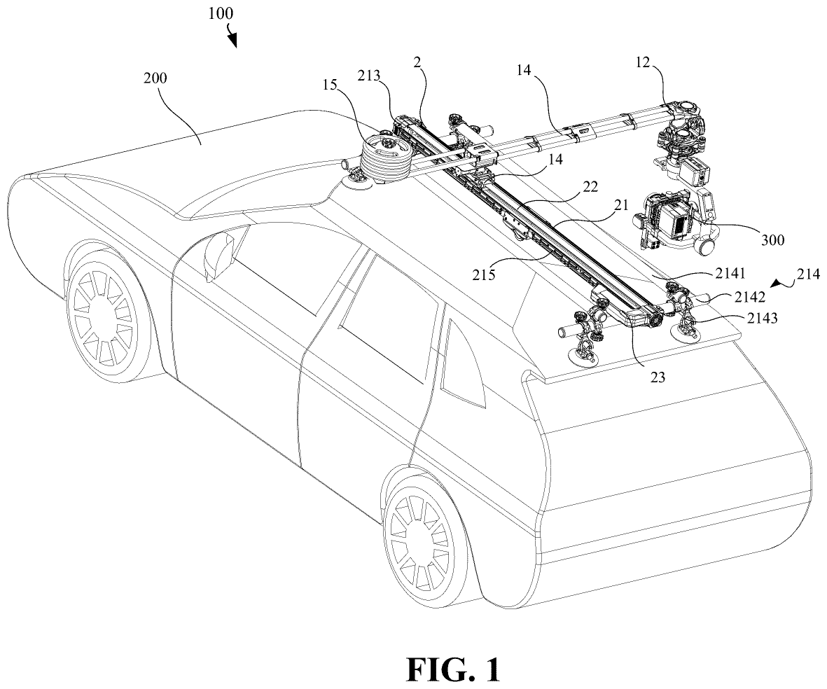

Referring to FIGS. 1-6, a vehicle-mounted shooting system 100 is disclosed by this application, incorporating a connecting assembly 1 and a sliding rail assembly 2. The connecting assembly 1 serves to assemble or support photographic equipment 300, while the sliding rail assembly 2 encompasses a sliding rail base 21, a conveyor belt 22, and a mobile drive component 23. The connecting assembly 1 is movably mounted on the sliding rail base 21 and linked to the conveyor belt 22. The conveyor belt 22 is positioned on the sliding rail base 21, and the mobile drive component 23, also situated on the sliding rail base 21, is drivingly coupled to the conveyor belt 22 to propel its movement relative to the sliding rail base 21, thereby facilitating the movement of the connecting assembly 1 along the sliding rail base 21. In some examples, the conveyor belt 22 can be a timing belt, a leather belt, or similar.

In some examples, jib arms are commonly utilized for capturing interior and exterior scenes of vehicles. When transitioning between scenes, for instance, from the front to the rear of the vehicle, the camera load end 12 of the jib arm must be rotated accordingly. During this rotation, to prevent damage to the vehicle 200, the camera load end 12 typically needs to extend beyond the body of the vehicle 200. Such a setup significantly limits the shooting environment.

In some aspects, when it is necessary to switch shooting scenes, the connecting assembly 1 is movable on the sliding rail base 21 and can traverse along with the conveyor belt 22. Consequently, the conveyor belt 22 can propel the connecting assembly 1 to slide along the sliding rail base 21, enabling the camera load end 12 to follow this motion to accommodate the user's shooting scene transitions. This arrangement saves the camera load end 12 of the connecting assembly 1 from protruding outside the vehicle body, yet the vehicle-mounted shooting system 100 occupies minimal space and is adaptable to a wide range of shooting environments.

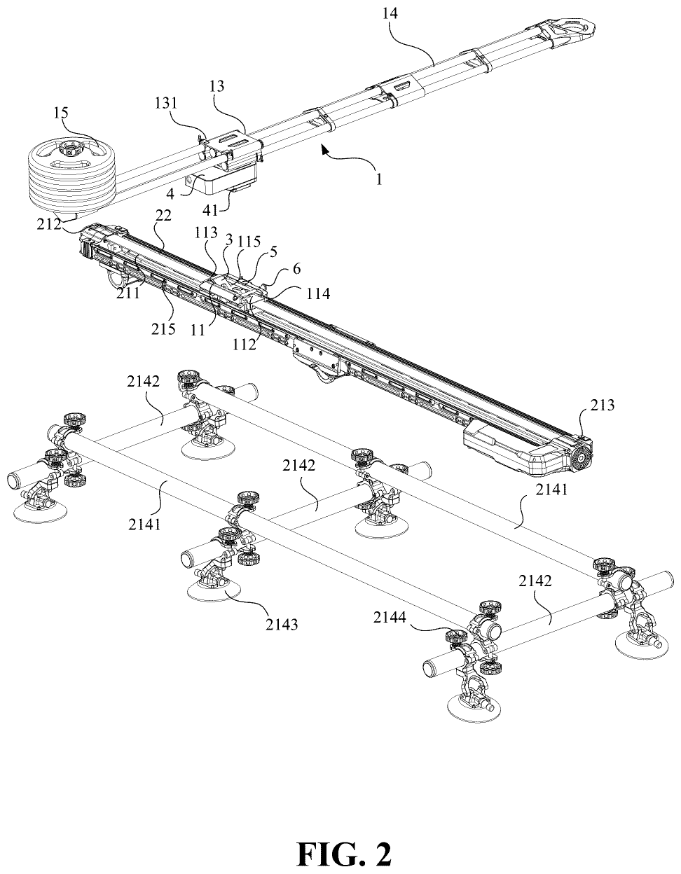

Referring to FIG. 2, for the movement of the connecting assembly 1 on the sliding rail base 21, in one embodiment, the connecting assembly 1 is equipped with a mobile platform 11, which is movably mounted on the sliding rail base 21 and linked to the conveyor belt 22, so that, upon operation of the conveyor belt 22, it propels the mobile platform 11 along the sliding rail base 21.

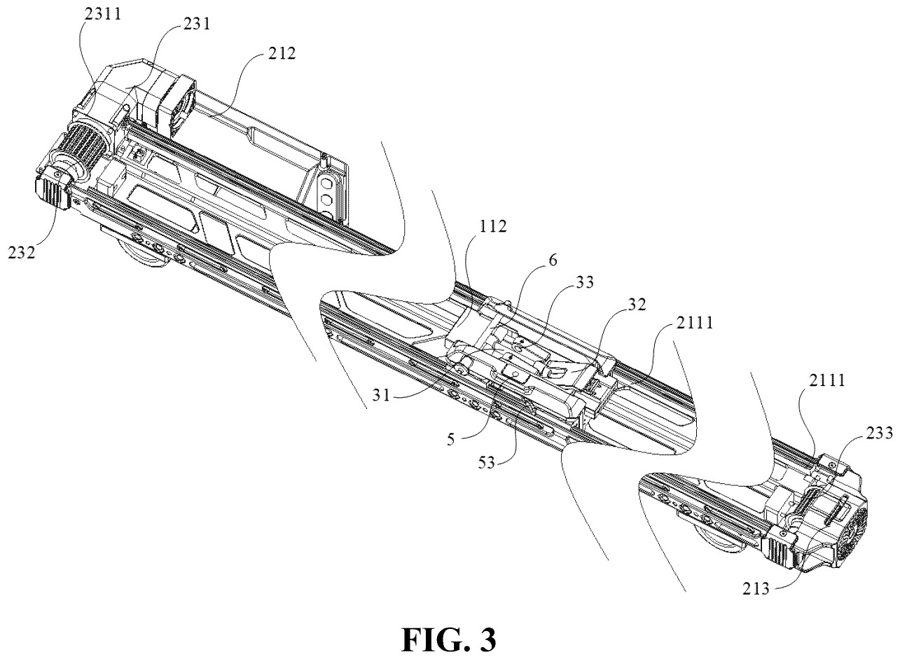

Referring to FIG. 3, in some aspects, the mobile drive component 23 includes a mobile drive motor 231, a driving wheel 232, and a driven wheel 233. The sliding rail base 21 features a first sliding groove 211 within which the mobile platform 11 slides. A first fixed base 212 and a second fixed base 213 are positioned at opposite ends of the sliding rail base 21. The mobile drive motor 231 is securely mounted on the first fixed base 212, with its output end 2311 linked to the driving wheel 232. The driving wheel 232 is movably mounted on the first fixed base 212, while the driven wheel 233 is movably mounted on the second fixed base 213. The conveyor belt 22, accommodated within the first sliding groove 211, has its ends mounted on the driving wheel 232 and the driven wheel 233, respectively. When the mobile drive motor 231 powers the driving wheel 232 and the driven wheel 233 to rotate, the conveyor belt 22 propels the mobile platform 11 to move along the first sliding groove 211.

In this embodiment, the sliding rail base 21 can be installed atop the vehicle roof, extending along the length of the vehicle 200. The mobile drive motor 231 operates the conveyor belt 22 within the first sliding groove 211. The movement of the conveyor belt 22 drives the mobile platform 11 to traverse along the length of the sliding rail base 21 (e.g., from near the front to near the rear of the vehicle on the sliding rail base 21), thereby enabling seamless scene transitions between the front and rear of the vehicle 200 without requiring the camera load end 12 of the connecting assembly 1 to extend beyond the vehicle body.

In an alternative embodiment, the connecting assembly 1 is equipped with a mobile platform 11, which is movably mounted on the sliding rail base 21 and linked to the conveyor belt 22. By connecting the conveyor belt 22 to the mobile platform 11, the conveyor belt 22 propels the mobile platform 11 during its movement, thus displacing the connecting assembly 1. In this embodiment, the arrangement of the mobile platform 11 sliding on the sliding rail base 21 facilitates a more stable movement of the connecting assembly 1. Specifically, the sidewalls on both sides of the first sliding groove 211 are equipped with sliding strips 2111, and third sliding grooves 111 are arranged on both sides of the mobile platform 11 to slide along these strips 2111. This configuration ensures stable sliding of the mobile platform 11 within the first sliding groove 211.

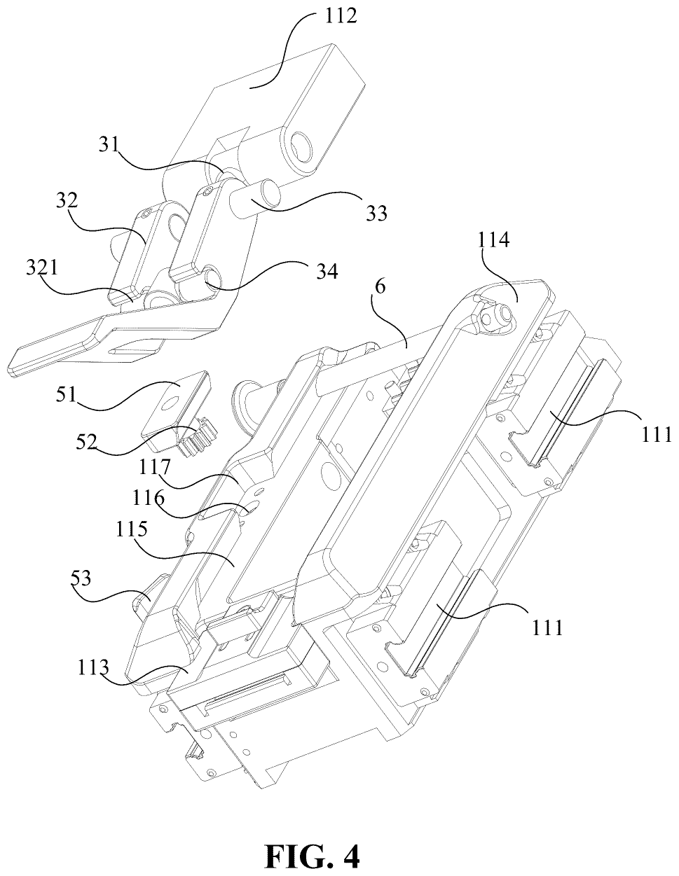

Referring to FIG. 2 and FIG. 4, in some aspects, a tensioning assembly 3 is also included in the vehicle-mounted shooting system. The mobile platform 11 incorporates a movable block 112 capable of moving relative to the mobile platform 11. A first end of the conveyor belt 22 is attached to a first end 113 of the mobile platform 11, while a second end is connected to the movable block 112, which is linked to a second end 114 of the mobile platform 11. The tensioning assembly 3, movably connected to both the mobile platform 11 and the movable block 112, can propel the movable block 112 to move relative to the mobile platform 11, thereby tensioning or loosening the conveyor belt 22. In this embodiment, for example, when the conveyor belt 22 is relatively loose, it may be difficult to move and prone to slipping off the driving wheel 232 and driven wheel 233. Additionally, in the case of a loose conveyor belt 22, there may be a lag in the mobile platform 11 following the movement of the conveyor belt 22. Collectively, these factors are detrimental to the operation of the vehicle-mounted camera system 100. Therefore, in this embodiment, the tensioning assembly 3 adjusts the tension of the conveyor belt 22, facilitating smoother movement of the mobile platform 11 by the conveyor belt 22.

Specifically, referring to FIG. 4, the tensioning assembly 3 includes a connecting rod 31 and an operating part 32. A first end of the connecting rod 31 is movably connected to the movable block 112, while a second end is movably linked to the operating part 32, which is pivotally connected to the mobile platform 11 via a pivot 33. When the operating part 32 rotates towards the first end 113 of the mobile platform 11, the movable block 112 moves towards the first end 113 of the mobile platform 11; conversely, when the operating part 32 rotates towards the second end 114 of the mobile platform 11, the movable block 112 moves towards the second end 114 of the mobile platform 11. The conveyor belt 22 is slackened by moving it towards the second end 114 of the mobile platform 11. Specifically, the operating part 32 performs eccentric rotation around the pivot 33. When the operating part 32 rotates and locks in the direction towards the first end 113 of the mobile platform 11, the end of the connecting rod 31 connected to the operating part 32 moves along with it towards the first end 113 of the mobile platform 11. Since the length of the connecting rod 31 is fixed, the opposite end of the connecting rod 31 moves the movable block 112 towards the first end 113 of the mobile platform 11, further tensioning the conveyor belt 22. In greater detail, the operating part 32 features a housing groove 321, and the end of the connecting rod 31 opposite the movable block 112 is connected to a resistance rod 34, which is latched into the housing groove 321. This setup allows the operating part 32 to rotate and drive the connecting rod 31 via the resistance rod 34. The approach of latching the resistance rod 34 into the housing groove 321 also facilitates disassembly of the connecting rod 31 and the operating part 32, further aiding in the removal of the conveyor belt 22 from the sliding rail base 21.

The sliding rail base 21 includes a support part 214 and a sliding rail 215. The support part 214 is affixed to one side of the sliding rail facing away from the connecting assembly 1, or it extends with a first end connected to the sliding rail 215 and a second end radiating outward. The sliding rail base 21 can be mounted atop the vehicle 200 via the support part 214, thereby positioning the vehicle-mounted camera system 100 on the vehicle's roof. Regarding the installation of the support part 214, in one embodiment, it is attached to the underside of the sliding rail base 21 to support the sliding rail 215. In another embodiment, one end of the support part 214 is connected to the sliding rail 215, while the other end extends radially around the sliding rail 215′s center.

In one embodiment, referring to FIG. 2, when the support part 214 is connected to one side of the sliding rail 215 facing away from the connecting assembly 1, the support part 214 incorporates a plurality of first support rods 2141 and a plurality of second support rods 2142, interwoven horizontally and vertically to stabilize and attach the sliding rail 215 to the vehicle 200. The plurality of first support rods 2141 and second support rods 2142 intersect in a grid pattern, both horizontally and vertically. Specifically, a number of first support rods 2141 are arranged along the length of the sliding rail 215 (this embodiment illustrates with two first support rods 2141), and a number of second support rods 2142 are arranged along its width. The midpoint of each second support rod 2142 is connected to the bottom of the sliding rail 215 (this embodiment illustrates with two second support rods 2142), with both ends of each second support rod 2142 linked to the first support rods 2141. This arrangement secures the sliding rail 215 atop the vehicle 200. For example, both first support rods 2141 and second support rods 2142 can be either mounted directly on the vehicle 200′s top or on a luggage rack.

In an alternative embodiment, a plurality of suction cups 2143 is included in the support part 214. These suction cups 2143 are attached to one side of the first support rods 2141 and/or the second support rods 2142 facing away from the sliding rail 215, enabling the rods 2141 and 2142 to be securely mounted on the vehicle 200. In this embodiment, the positioning of the suction cups 2143 is flexible. For instance, the end of each second support rod 2142 may be attached to a suction cup 2143, or the end of each first support rod 2141 may be linked to one, or both types of support rods may be connected to suction cups 2143. This allows the second support rods 2142 to adhere to the vehicle's roof. Adjustable fixing clamps 2144 are utilized to connect the first and second support rods 2141, 2142, as well as to attach the second support rods 2142 to the suction cups 2143.

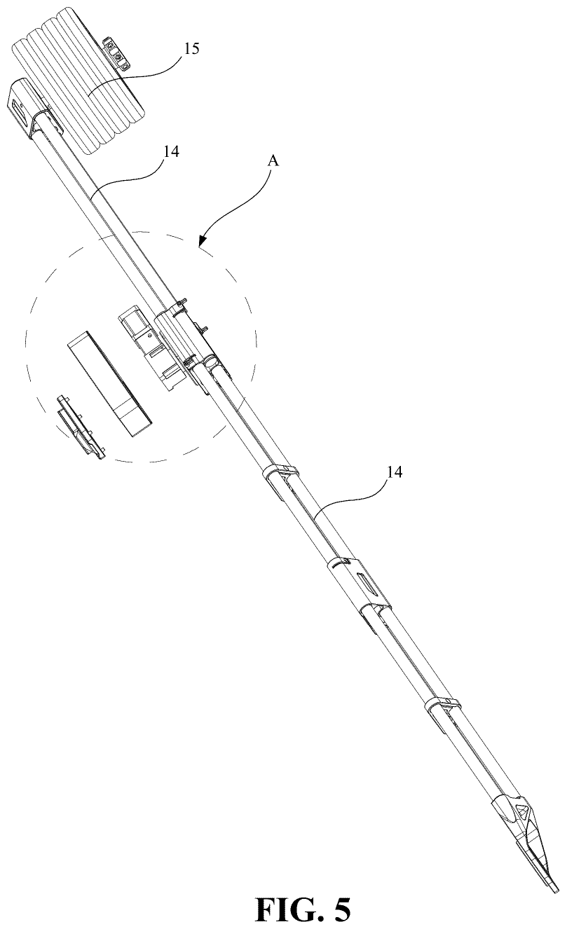

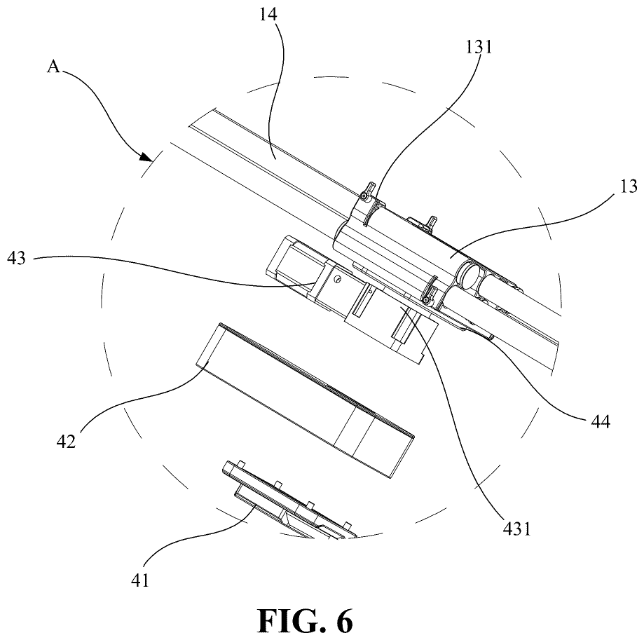

Referring to FIGS. 5-6, in an alternative embodiment, a rotational drive component 4 equipped to the connecting assembly 1 is connected to the mobile platform 11, enabling the connecting assembly 1 to rotate relative to the mobile platform 11. The rotational drive component 4 enables the connecting assembly 1 to rotate relative to the mobile platform 11, facilitating the transition from one side of the vehicle to the other for shooting. In conjunction with the connecting assembly's 1 ability to traverse the length of the sliding rail base 21 via the mobile drive assembly 23, this setup achieves comprehensive interior and exterior scene capture for the vehicle 200.

The vehicle-mounted shooting system 100 also includes a locking assembly 5. The mobile platform 11 features a second sliding groove 115 on the top, and a slider 41 is positioned on one side of the rotational drive component 4 facing away from the connecting assembly 1. This slider 41 moves within the second sliding groove 115, while the locking assembly 5, connected to the mobile platform 11, extends into the second sliding groove 115 to secure the slider 41 in place. Specifically, the mobile platform 11 features a through hole 116 and an installation groove 117. The locking assembly 5 includes a locking block 51, a locking post 52, and a locking lever 53. The locking block 51 resides within the installation groove 117, while the locking post 52 passes through the through hole 116, with one end connected to the locking block 51 and the other to the locking lever 53. When the locking lever 53 is actuated, it causes the locking post 52 to move, which in turn moves the locking block 51, pressing it against the slider 41 to secure the rotational drive component 4.

The vehicle-mounted shooting system 100 incorporates a stopper 6 at either end of the sliding groove, serving to limit the slider 41′s position. This configuration prevents the rotational drive component 4 from dislodging from the second sliding groove 115 during installation.

The connecting assembly 1 includes a connecting base 13 and a cantilever 14, where the cantilever 14 connects to the connecting base 13 for photographic equipment 300 assembly. In this setup, when the rotational drive component 4 is not utilized, the connecting base 13 attaches to the mobile platform 11; when the rotational drive component 4 is incorporated, the connecting base 13 attaches to the rotational drive component 4, which then rotates the cantilever 14 via the connecting base 13. Specifically, the rotational drive component 4 includes a housing 42, a rotating drive motor 43, and a fixed disk 44. The rotating drive motor 43 resides within the housing 42, with the housing's bottom featuring a slider 41. The fixed disk 44 is fixed to the bottom of the connecting base 13 and connects to the rotating drive motor's output end 431. The rotating drive motor 43 rotates the fixed disk 44 and the connecting base 13 relative to the housing 42, thereby rotating the cantilever 14.

Furthermore, multiple tube clamps 131 are positioned on opposite sides of the connecting base 13, and the cantilever 14 includes multiple sections that fit within the tube clamps 131 on both sides of the connecting base 13 for mounting photographic equipment 300 or counterweights 15. The counterweights 15 and photographic equipment 300 must be positioned on opposite sides of the connecting base 13 to maintain balance through the counterweights 15. It is noteworthy that the cantilever 14 can be adjusted within the tube clamp 131 to modify the distance between the photographic equipment 300 or counterweights 15 and the connecting base 13.

It is emphasized that the aforementioned embodiments serve as preferred illustrations and do not constitute limitations on the scope of the patent claims presented herein. Any structural modifications that are deemed equivalent, based on the disclosure and drawings of this application, or their direct/indirect application in related technical domains, fall within the ambit of patent protection afforded to this application, in line with its underlying concept.

What is claimed is:

1. A vehicle-mounted shooting system, comprising:
a connecting assembly for assembling photographic equipment; and
a sliding rail assembly, comprising a sliding rail base, a conveyor belt, and a mobile drive component,
wherein the connecting assembly is movably mounted on the sliding rail base and connected to the conveyor belt; and
wherein the conveyor belt is positioned on the sliding rail base, and the mobile drive component, provided on the sliding rail base, is drivingly coupled to the conveyor belt to propel a movement of the conveyor belt relative to the sliding rail base, facilitating a movement of the connecting assembly along the sliding rail base.

2. The vehicle-mounted shooting system according to claim 1, wherein the
connecting assembly comprises a mobile platform, and
wherein the mobile platform is movably mounted on the sliding rail base and connected to the conveyor belt.

3. The vehicle-mounted shooting system according to claim 2, wherein the connecting assembly further comprises a rotational drive component connected to the mobile platform, enabling the connecting assembly to rotate relative to the mobile platform.

4. The vehicle-mounted shooting system according to claim 2, wherein the sliding rail assembly comprises a tensioning assembly;
wherein the mobile platform comprises a movable block capable of moving relative to the mobile platform;
wherein a first end of the conveyor belt is connected to a first end of the mobile platform, and a second end of the conveyor belt is connected to the movable block, and the movable block is movably connected to a second end of the mobile platform; and
wherein the tensioning assembly, connected to both the mobile platform and the movable block, is configured to propel the movable block to move relative to the mobile platform, tensioning or loosening the conveyor belt.

5. The vehicle-mounted shooting system according to claim 4, wherein the tensioning assembly comprises a connecting rod and an operating part;
wherein a first end of the connecting rod is movably connected to the movable block, and a second end is movably connected to the operating part, and the operating part is pivotally connected to the mobile platform;
wherein the movable block moves towards the first end of the mobile platform in response to the operating part rotating towards the first end of the mobile platform; and
wherein, the movable block moves towards the second end of the mobile platform in response to the operating part rotating towards the second end of the mobile platform.

6. The vehicle-mounted shooting system according to claim 2, wherein the mobile drive component comprises a mobile drive motor, a driving wheel, and a driven wheel;
wherein the sliding rail base comprises a first sliding groove within which the mobile platform slides;
wherein the sliding rail base comprises a first fixed base and a second fixed base that are respectively positioned at opposite ends of the sliding rail base;
wherein the mobile drive motor is mounted on the first fixed base, with an output end of the mobile drive motor connected to the driving wheel;
wherein the driving wheel is mounted on the first fixed base, and the driven wheel is mounted on the second fixed base;
wherein the conveyor belt is accommodated within the first sliding groove, and two ends of the conveyor belt mounted on the driving wheel and the driven wheel, respectively; and
wherein the conveyor belt is configured to propel the mobile platform to move along the first sliding groove in response to the mobile drive motor powering the driving wheel and the driven wheel to rotate.

7. The vehicle-mounted shooting system according to claim 1, wherein the sliding rail base comprises a support part and a sliding rail; and
wherein the support part is affixed to one side of the sliding rail facing away from the connecting assembly.

8. The vehicle-mounted shooting system according to claim 1, wherein the sliding rail base comprises a support part and a sliding rail; and
the support part extends with a first end connected to the sliding rail and a second end of the support part radiating outward.

9. The vehicle-mounted shooting system according to claim 8, wherein the support part comprises a plurality of first support rods and a plurality of second support rods, interwoven horizontally and vertically to stabilize and connect the sliding rail to a vehicle.

10. The vehicle-mounted shooting system according to claim 9,
wherein the support part comprises a plurality of suction cups; and
wherein the plurality of suction cups are connected to one side of at least one of the first support rods or the second support rods facing away from the sliding rail, enabling the first support rods and the second support rods to be securely mounted on the vehicle.

11. The vehicle-mounted shooting system according to claim 3, wherein the mobile platform comprises a locking assembly;
wherein the mobile platform features a second sliding groove, and a slider is positioned on one side of the rotational drive component facing away from the connecting assembly; and
wherein the slider moves within the second sliding groove, and the locking assembly, connected to the mobile platform, extends into the second sliding groove to secure the slider in place.

12. The vehicle-mounted shooting system according to claim 11, further comprising a stopper at one end of the second sliding groove.

13. The vehicle-mounted shooting system according to claim 2, wherein the connecting assembly comprises a connecting base and a cantilever, and the connecting base is mounted on the mobile platform, with the cantilever attached to the connecting base for assembling photographic equipment.

14. The vehicle-mounted shooting system according to claim 3, wherein the connecting assembly comprises a connecting base and a cantilever, and the connecting base is mounted on the rotational drive component, with the cantilever attached to the connecting base for assembling photographic equipment.
